(19) United States
(12) Patent Application Publication
(10) Pub. No.: US 2025/0326236 A1
(43) Pub. Date: Oct. 23, 2025

(54) DRYING APPARATUS AND DRYING METHOD

(71) Applicant: SCREEN Holdings Co., Ltd., Kyoto (JP)

(72) Inventors: Kenta HIRAMATSU, Kyoto-shi (JP); Ryota UEMURA, Kyoto-shi (JP)

(21) Appl. No.: 19/176,241

(22) Filed: Apr. 11, 2025

(30) Foreign Application Priority Data
Apr. 23, 2024 (JP) 2024-069466

(51) Int. Cl. B41J 11/00; B41J 2/21

(52) U.S. Cl. CPC B41J 11/00242; B41J 2/2117

(57) ABSTRACT

The control part has an outside air data acquisition part which acquires outside air data indicating at least the amount of water vapor contained in the outside air and a print image information acquisition part which acquires print image information of an image printed on the printing medium and controls the control target on the basis of the outside air data and the print image information.

### CROSS REFERENCE TO RELATED APPLICATION

The disclosure of Japanese Patent Application No. 2024-069466 filed on Apr. 23, 2024 including specification, drawings and claims is incorporated herein by reference in its entirety.

### BACKGROUND

### Technical Field

This disclosure relates to a technique for drying a printing medium on which an image formed of inks is printed.

### Background Art

Japanese Patent Application Laid Open Gazette No. 2023-119172 discloses a drying apparatus including a heating unit for drying a printing medium on which an image formed of inks is printed. The heating unit has a heating part facing the printing medium to heat the printing medium and a blowing machine for blowing air between the heating part and the printing medium. Further, a humidity detection part for detecting a humidity of an area between the heating unit and the printing medium is provided, and the blowing machine, for example, is controlled on the basis of the humidity detected by the humidity detection part.

### SUMMARY

In order to quickly dry the printing medium, it is required to dry the printing medium on a condition according to the humidity inside a drying furnace for drying the printing medium. In a case where a humidity sensor is disposed inside the drying furnace, in order to prevent any failure of the humidity sensor, the temperature inside the drying furnace cannot be made high and it is difficult to quickly dry the printing medium.

This disclosure is intended to solve the above-described problem, and it is an object of this disclosure to make it possible to dry a printing medium on a condition according to humidity inside a drying furnace without providing any humidity sensor inside the drying furnace.

A drying apparatus, according to the disclosure, comprises: a drying furnace; a transport part which transports a printing medium, on which an image formed of inks is printed, inside the drying furnace; a warm air supply part which takes in warm air generated by heating outside air, which is air outside the drying furnace, and supplies the warm air into the drying furnace; a warm air temperature adjustment part which adjusts a temperature of warm air taken in by the warm air supply part; a warm air guide part which guides warm air supplied into the drying furnace by the warm air supply part to the printing medium transported by the transport part; a warm air collecting part which collects warm air discharged from the drying furnace into the warm air supply part; and a control part which controls at least one control target among the transport part, the warm air temperature adjustment part, and the warm air collecting part, wherein the warm air supply part supplies warm air collected by the warm air collecting part into the drying furnace, and the control part has an outside air data acquisition part which acquires outside air data indicating at least the amount of water vapor contained in the outside air and a print image information acquisition part which acquires print image information of an image printed on the printing medium and controls the control target on the basis of the outside air data and the print image information.

A drying method, according to the disclosure, comprises: transporting a printing medium, on which an image formed of inks is printed, by a transport part inside a drying furnace; taking in warm air generated by heating outside air, which is air outside the drying furnace, and supplying the warm air into the drying furnace by a warm air supply part; adjusting a temperature of warm air that the warm air supply part takes in by a warm air temperature adjustment part; guiding warm air supplied into the drying furnace by the warm air supply part to the printing medium transported by the transport part, by a warm air guide part; collecting warm air discharged from the drying furnace into the warm air supply part by a warm air collecting part; and controlling at least one control target among the transport part, the warm air temperature adjustment part, and the warm air collecting part by a control part, wherein the warm air supply part supplies warm air collected by the warm air collecting part into the drying furnace, and the control part has an outside air data acquisition part, which acquires outside air data indicating at least the amount of water vapor contained in the outside air, and a print image information acquisition part, which acquires print image information of an image printed on the printing medium, and controls the control target on the basis of the outside air data and the print image information.

In the disclosure (the drying apparatus and the drying method) having such a configuration, the warm air generated by heating outside air is supplied into the drying furnace by the warm air supply part. The temperature of the warm air is adjusted by the warm air temperature adjustment part. Further, the warm air collected from the drying furnace into the warm air supply part by the warm air collecting part is also supplied into the drying furnace. Inside this drying furnace, the printing medium on which an image formed of inks is printed is transported by the transport part. Then, the warm air supplied into the drying furnace is guided to the printing medium by the warm air guide part, to thereby dry the printing medium. In such a configuration, the inks deposited on the printing medium to form the image and the humidity of the outside air significantly affect the humidity inside the drying furnace. Then, in the disclosure, the outside air data indicating at least the amount of water vapor contained in the outside air and the print image information of the image printed on the printing medium are acquired. Then, at least one control target among the transport part, the warm air temperature adjustment part, and the warm air collecting part is controlled on the basis of the outside air data and the print image information. As a result, without providing any humidity sensor inside the drying furnace, it becomes possible to dry the printing medium on the condition according to the humidity inside the drying furnace.

Thus, according to the disclosure, without providing any humidity sensor inside the drying furnace, it becomes possible to dry the printing medium on the condition according to the humidity inside the drying furnace.

The above and further objects and novel features of the disclosure will more fully appear from the following detailed description when the same is read in connection with the accompanying drawing. It is to be expressly understood, however, that the drawing is for purpose of illustration only and is not intended as a definition of the limits of the disclosure.

### BRIEF DESCRIPTION OF THE DRAWINGS

FIG. 1 is an elevational view schematically showing one example of a printing system including a drying apparatus in accordance with the disclosure;

FIG. 2 is an elevational view schematically showing the drying apparatus included in the printing system shown in FIG. 1;

FIG. 3 is a schematic view showing respective blower dryers of an upper-stage transport part and a lower-stage transport part which are partially enlarged;

FIG. 4 is a schematic view showing blower dryers of a middle-stage transport part which is partially enlarged;

FIG. 5 is a block diagram showing a warm air supply unit for supplying warm air into a drying furnace;

FIG. 6 is a block diagram showing an electrical configuration included in the drying apparatus;

FIG. 7A is a flowchart showing a first example of drying condition determination performed by a control part of the drying apparatus;

FIG. 7B is a view schematically showing an exemplary arithmetic operation performed in the flowchart of FIG. 7A;

FIG. 7C is a view schematically showing another exemplary arithmetic operation performed in the flowchart of FIG. 7A;

FIG. 7D is a view schematically showing an exemplary table used for setting a drying condition in the flowchart of FIG. 7A;

FIG. 7E is a view schematically showing another exemplary table used for setting a drying condition in the flowchart of FIG. 7A;

FIG. 8A is a flowchart showing a second example of drying condition determination performed by the control part of the drying apparatus;

FIG. 8B is a view schematically showing an exemplary arithmetic operation performed in the flowchart of FIG. 7A;

FIG. 8C is a view schematically showing another exemplary arithmetic operation performed in the flowchart of FIG. 7A; and

FIG. 9 is a flowchart showing a third example of drying condition determination performed by the control part of the drying apparatus.

### DETAILED DESCRIPTION

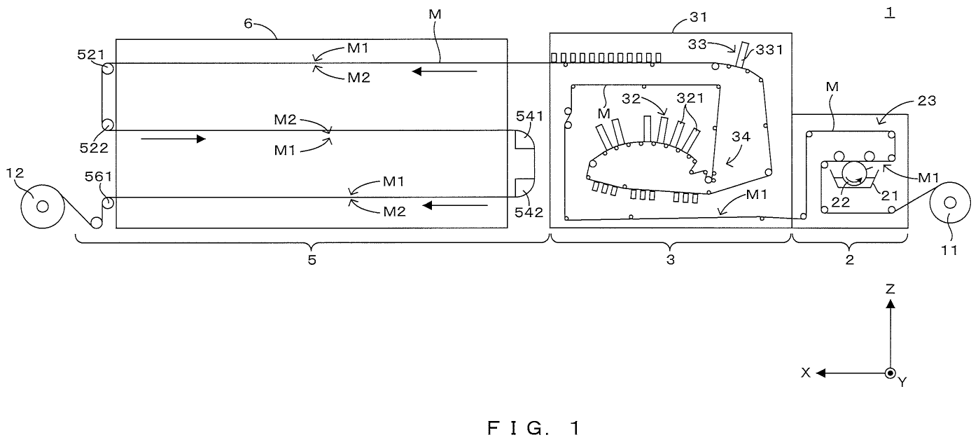

FIG. 1 is an elevational view schematically showing one example of a printing system including a drying apparatus in accordance with the disclosure. In FIG. 1 and the following figures, a horizontal direction X, a horizontal direction Y orthogonal to the horizontal direction X, and a vertical direction Z are shown as appropriate. As shown in FIG. 1, a printing system 1 includes a configuration in which a coating apparatus 2, a printer 3, and a drying apparatus 5 are arranged in this order in the horizontal direction X (arrangement direction). This printing system 1 transports a long strip-like printing medium M from a feed roll 11 to a wind-up roll 12 in a roll-to-roll manner while causing the printer 3 to print an image by an inkjet method on the printing medium M onto which the coating apparatus 2 applies a coating liquid and further causing the drying apparatus 5 to dry the printing medium M on which the image is printed. The material of the printing medium M is a film such as OPP (oriented polypropylene), PET (polyethylene terephthalate), or the like. The material of the printing medium M, however, is not limited to the film but may be paper or the like. Such a printing medium M has flexibility. Furthermore, hereinafter, among both surfaces of the printing medium M, the surface on which an image is printed is referred to as a front surface M1 and the other surface opposite to the front surface M1 is referred to as a back surface M2 as appropriate.

The coating apparatus 2 has a pan 21 which stores therein a liquid primer (coating liquid), a gravure roller 22 which is partially immersed in the primer stored in the pan 21, and a transport part 23 for transporting the printing medium M. In the coating apparatus 2, provided is a coating area in which the gravure roller 22 comes into contact with the printing medium M from below, which is transported by the transport part 23, and the transport part 23 transports the printing medium M along the coating area with the front surface M1 of the printing medium M facing downward. On the other hand, the gravure roller 22 rotates while holding the primer on a peripheral surface thereof, to thereby supply the primer to the coating area. Thus, the primer supplied by the gravure roller 22 is applied onto the front surface M1 of the printing medium M in the coating area. Further, in the coating area, a traveling direction of the printing medium M is reverse to a rotation direction of the peripheral surface of the gravure roller 22. In other words, the primer is applied to the printing medium M by so-called reverse kiss coating. Then, the transport part 23 unloads the printing medium M from the coating apparatus 2 into the printer 3 with the front surface M1 of the printing medium M on which the primer is applied, facing upward.

The printer 3 includes a housing 31, a color printing part 32 disposed inside the housing 31, a white printing part 33 disposed above the color printing part 32 inside the housing 31, and a transport part 34 for transporting the printing medium M by using a plurality of rollers disposed inside the housing 31.

The color printing part 32 has a plurality of (six) ejection heads 321 arranged in the traveling direction of the printing medium M above the printing medium M transported by the transport part 34. The plurality of ejection heads 321 have respective nozzles facing, from above, the front surface M1 of the printing medium M going through therebelow, and eject color inks of different colors by an inkjet method from the respective nozzles. Herein, the color ink refers to ink of any color other than white, including inks of cyan, magenta, yellow, black, and the like. Thus, the plurality of ejection heads 321 of the color printing part 32 eject color inks, from above, onto the front surface M1 of the printing medium M going through therebelow, to thereby print a color image on the front surface M1 of the printing medium M.

Further, the white printing part 33 has a single ejection head 331 disposed above the printing medium M transported by the transport part 34. The ejection head 331 has a nozzle facing, from above, the front surface M1 of the printing medium M going through therebelow, and ejects white ink by an inkjet method from the nozzle. Thus, the ejection head 331 of the white printing part 33 ejects white ink, from above, onto the front surface M1 of the printing medium M going through therebelow, to thereby print a white image on the front surface M1 of the printing medium M.

The printing medium M is loaded into the housing 31 of the printer 3 from the coating apparatus 2, with the front surface M1 facing upward. On the other hand, the transport part 34 inverts front to back twice the printing medium M loaded into the housing 31 and then transports the printing medium M to the color printing part 32. Each of the ejection heads 321 of the color printing part 32 can thereby eject color ink onto the front surface M1 of the printing medium M facing upward. Further, the transport part 34 inverts front to back twice the printing medium M on which the color inks are deposited and then transports the printing medium M to the white printing part 33. The ejection head 331 of the white printing part 33 can thereby eject white ink onto the front surface M1 of the printing medium M facing upward. Thus, the printing medium M having the front surface M1 on which the color inks and the white ink are deposited is transported from the printer 3 to the drying apparatus 5 by the transport part 34.

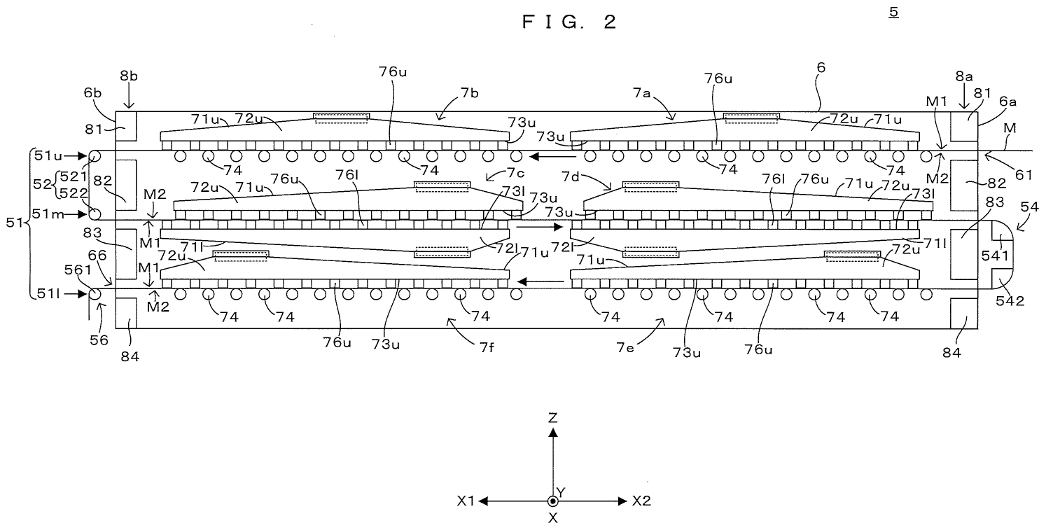

FIG. 2 is an elevational view schematically showing the drying apparatus included in the printing system shown in FIG. 1. In this figure, one side X1 and the other side X2 in the horizontal direction X are shown, and the one side X1 and the other side X2 face opposite sides to each other. The drying apparatus 5 dries the printing medium M while transporting the printing medium M, being turned around as appropriate in the horizontal direction X. This drying apparatus 5 includes a drying furnace 6 disposed on the one side X1 of the housing 31 of the printer 3. This drying furnace 6 is an enclosure having a rectangular parallelepiped shape extending in the horizontal direction X, and both sidewalls 6a and 6b of the drying furnace 6 in the horizontal direction X are in parallel with the vertical direction Z and perpendicular to the horizontal direction X, facing each other with an interval in the horizontal direction X.

In the sidewall 6a on the other side X2 (on the side of the printer 3) in the horizontal direction X among the sidewalls 6a and 6b, a loading port 61 penetrates in the horizontal direction X, and in the sidewall 6b on the one side X1 (on the opposite side of the printer 3) in the horizontal direction X, an unloading port 66 penetrates in the horizontal direction X. Then, the printing medium M unloaded out from the printer 3 is loaded into the drying furnace 6 from the loading port 61 and then unloaded to the outside of the drying furnace 6 from the unloading port 66.

Specifically, the drying apparatus 5 includes a transport part 51 for transporting the printing medium M inside the drying furnace 6, and the transport part 51 transports the printing medium M from the loading port 61 to the unloading port 66. This transport part 51 has an upper-stage transport part 51u for transporting the printing medium M from the other side X2 toward the one side X1, a middle-stage transport part 51m for transporting the printing medium M from the one side X1 toward the other side X2, and a lower-stage transport part 51l for transporting the printing medium M from the other side X2 toward the one side X1. The middle-stage transport part 51m is disposed below the upper-stage transport part 51u, and the lower-stage transport part 51l is disposed below the middle-stage transport part 51m. Therefore, the printing medium M transported by the upper-stage transport part 51u, the printing medium M transported by the middle-stage transport part 51m, and the printing medium M transported by the lower-stage transport part 51l are aligned in the vertical direction Z, and in other words, these printing media M overlap one another as viewed from the vertical direction Z. Specifically, the upper-stage transport part 51u transports the printing medium M at the same height as the loading port 61, and the printing medium M is transported in the horizontal direction X by the upper-stage transport part 51u with the front surface M1 facing upward and the back surface M2 facing downward. The middle-stage transport part 51m transports the printing medium M below the upper-stage transport part 51u, and the printing medium M is transported in the horizontal direction X by the middle-stage transport part 51m with the front surface M1 facing downward and the back surface M2 facing upward. The lower-stage transport part 51l transports the printing medium M below the middle-stage transport part 51m, and the printing medium M is transported in the horizontal direction X by the lower-stage transport part 51l with the front surface M1 facing upward and the back surface M2 facing downward.

Further, the transport part 51 has a prestage turnaround part 52 for turning around the printing medium M from the upper-stage transport part 51u to the middle-stage transport part 51m. This prestage turnaround part 52 has two rollers 521 and 522 arranged in the vertical direction Z on the one side X1 of the drying furnace 6. Each of the rollers 521 and 522 is disposed in parallel with the horizontal direction Y and supported by the drying furnace 6 about a rotation axis in parallel with the horizontal direction Y. Among the rollers 521 and 522, the upper roller 521 is wound with the back surface M2 of the printing medium M transported to the one side X1 by the upper-stage transport part 51u, to thereby turn around the printing medium M downward, and the lower roller 522 is wound with the back surface M2 of the printing medium M turned around downward by the roller 521, to thereby turn around the printing medium M to the other side X2.

Thus, when the printing medium M is turned around from the one side X1 to the other side X2 by the prestage turnaround part 52, the front surface M1 and the back surface M2 of the printing medium M are inverted upside down. The printing medium M turned around to the other side X2 by the prestage turnaround part 52 is transported toward the other side X2 by the middle-stage transport part 51m.

Further, the transport part 51 has a post-stage turnaround part 54 for turning around the printing medium M from the middle-stage transport part 51m to the lower-stage transport part 51l. This post-stage turnaround part 54 has two air turn bars 541 and 542 arranged in the vertical direction Z on the other side X2 of the drying furnace 6. Each of the air turn bars 541 and 542 is disposed in parallel with the horizontal direction Y and supported by the drying furnace 6. Among the air turn bars 541 and 542, the upper air turn bar 541 injects air onto the front surface M1 of the printing medium M transported from the middle-stage transport part 51m toward the other side X2. The air turn bar 541 thereby bends the printing medium M downward with a gap left between itself and the front surface M1 of the printing medium M. Further, among the air turn bars 541 and 542, the lower air turn bar 542 injects air onto the front surface M1 of the printing medium M transported downward from the air turn bar 541. The air turn bar 542 thereby bends the printing medium M to the one side X1 with a gap left between itself and the front surface M1 of the printing medium M.

Thus, when the printing medium M is turned around from the other side X2 to the one side X1 by the post-stage turnaround part 54, the front surface M1 and the back surface M2 of the printing medium M are inverted upside down. The printing medium M turned around to the one side X1 by the post-stage turnaround part 54 is transported toward the one side X1 by the lower-stage transport part 51l.

Further, the transport part 51 has a roller 561 for supporting the printing medium M transported from the lower-stage transport part 51l to the one side X1. This roller 561 is disposed in parallel with the horizontal direction Y on the one side X1 of the drying furnace 6 and supported by the drying furnace 6 rotatably about the rotation axis in parallel with the horizontal direction Y. Then, the roller 561 rotates while being in contact with the back surface M2 of the printing medium M transported from the lower-stage transport part 51l toward the one side X1, to thereby support the printing medium M.

This drying apparatus 5 includes six blower dryers 7a to 7f accommodated in the drying furnace 6. Among these blower dryers, the two blower dryers 7a and 7b are provided in the upper-stage transport part 51u and arranged between the loading port 61 and the roller 521. Then, the blower dryers 7a and 7b dry the printing medium M transported from the loading port 61 toward the roller 521. The two blower dryers 7c and 7d are provided in the middle-stage transport part 51m and arranged between the roller 522 and the air turn bar 541. Then, the blower dryers 7c and 7d dry the printing medium M transported from the roller 522 toward the air turn bar 541. The two blower dryers 7e and 7f are provided in the lower-stage transport part 51l and arranged between the air turn bar 542 and the roller 561. Then, the blower dryers 7e and 7f dry the printing medium M transported from the air turn bar 542 toward the roller 561.

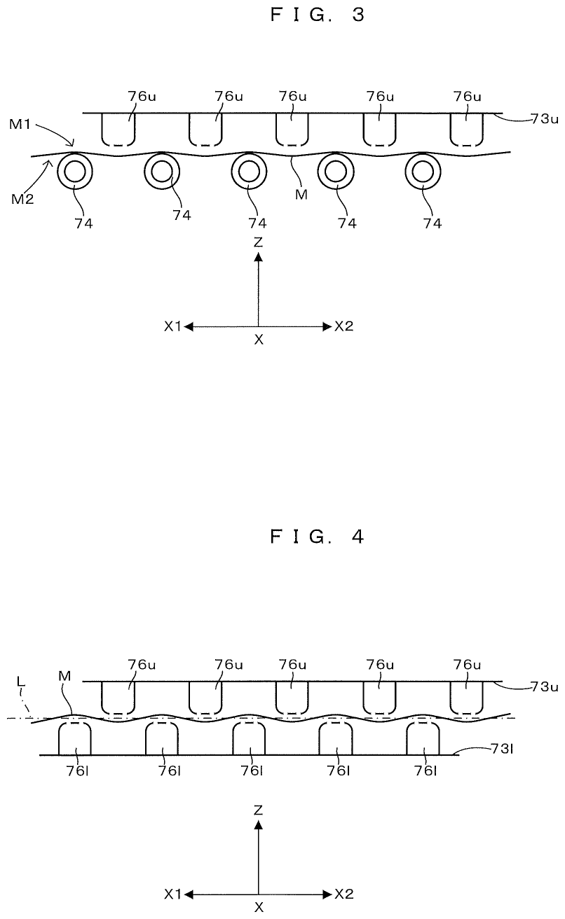

FIG. 3 is a schematic view showing the respective blower dryers of the upper-stage transport part and the lower-stage transport part which are partially enlarged, and FIG. 4 is a schematic view showing the blower dryers of the middle-stage transport part which are partially enlarged. Subsequently, the blower dryers 7a to 7f will be described, with reference to FIGS. 3 and 4.

The blower dryer 7a has a blower unit 71u arranged above the printing medium M transported from the loading port 61 toward the roller 521. The blower unit 71u has a blower chamber 72u extended in the horizontal direction X above the printing medium M. Both end surfaces of the blower chamber 72u in the horizontal direction X are planes perpendicular to the horizontal direction X and in parallel with the vertical direction Z. To the blower chamber 72u, supplied is warm air generated by heating air outside the drying furnace 6. A lower surface of the blower chamber 72u is a nozzle arrangement plane 73u facing, from above, the front surface M1 (upper surface) of the printing medium M facing upward. The nozzle arrangement plane 73u is a plane in parallel with the horizontal direction X and perpendicular to the vertical direction Z. Further, the blower unit 71u has a plurality of nozzles 76u aligned at a predetermined pitch in the horizontal direction X in this nozzle arrangement plane 73u. Thus, the plurality of nozzles 76u are aligned between the nozzle arrangement plane 73u and the front surface M1 of the printing medium M to face the front surface M1 of the printing medium M. Each of the nozzles 76u communicates with the blower chamber 72u and the warm air supplied to the blower chamber 72u is injected onto the front surface M1 of the printing medium M from each nozzle 76u, to thereby dry the printing medium M. Thus, among the plurality of blower dryers 7a to 7f, the blower dryer 7a first dries the printing medium M loaded in the drying furnace 6.

Further, the blower dryer 7a has a plurality of rollers 74 (the same number as that of the nozzles 76u) disposed below the printing medium M transported from the loading port 61 toward the roller 521. The plurality of rollers 74 are aligned at a predetermined pitch in the traveling direction (horizontal direction X) of the printing medium M and a peripheral surface of each roller 74 comes into contact with the back surface M2 (lower surface) of the printing medium M from below. Then, each roller 74 supports the printing medium M from below while following the printing medium M to rotate about the rotation axis in parallel with the horizontal direction Y. Further, a fine groove is spirally provided on the roller 74, and it thereby becomes easier for air to go out from between the printing medium M and the peripheral surface of the roller 74.

The nozzles 76u face a range between two rollers 74 adjacent to each other in the horizontal direction X from above, and the rollers 74 face a range between two upper nozzles 76u adjacent to each other in the horizontal direction X from below. Specifically, in the horizontal direction X, the nozzles 76u and the rollers 74 are arranged alternately at a pitch which is half of a predetermined pitch and arranged alternately one by one in the horizontal direction X in a plan view from the vertical direction Z. In other words, the nozzles 76u and the rollers 74 are arranged in a staggered manner.

In such a configuration, as shown in FIG. 3, in a portion where the printing medium M faces the nozzle 76u, the printing medium M is pushed downward by the warm air from this nozzle 76u, to lean downward relative to an upper end of the roller 74, and in a portion where the printing medium M faces the roller 74, the printing medium M is supported by the roller 74. Therefore, the printing medium M is transported from the other side X2 toward the one side X1 in the horizontal direction X while waving between the upper end of the roller 74 and below the upper end.

The blower dryer 7b is disposed on the downstream side of the blower dryer 7a in the traveling direction of the printing medium M transported from the loading port 61 toward the roller 521. Like the blower dryer 7a, this blower dryer 7b has the blower unit 71u disposed above the printing medium M transported from the loading port 61 toward the roller 521 and the plurality of rollers 74 disposed below the printing medium M. In the blower dryer 7b, while the plurality of rollers 74 support the back surface M2 of printing medium M from below, the plurality of nozzles 76u (the same number as that of the rollers 74) in the blower unit 71u inject warm air onto the front surface M1 of the printing medium M from above, to thereby dry the printing medium M.

The blower dryer 7c has the blower units 71u and 71l disposed, respectively, above and below the printing medium M transported from the roller 522 toward the air turn bar 541. The upper blower unit 71u has the blower chamber 72u extending in the horizontal direction X above the printing medium M. Both end surfaces of the blower chamber 72u in the horizontal direction X are planes perpendicular to the horizontal direction X and in parallel with the vertical direction Z. To the blower chamber 72u, supplied is the warm air described above. The lower surface of the blower chamber 72u is the nozzle arrangement plane 73u facing, from above, the back surface M2 (upper surface) of the printing medium M facing upward. This nozzle arrangement plane 73u is a plane in parallel with the horizontal direction X and perpendicular to the vertical direction Z. Further, the blower unit 71u has the plurality of nozzles 76u aligned at a predetermined pitch in the horizontal direction X in this nozzle arrangement plane 73u. Thus, the plurality of nozzles 76u are aligned between the nozzle arrangement plane 73u and the back surface M2 of the printing medium M to face the back surface M2 of the printing medium M. Each of the nozzles 76u communicates with the blower chamber 72u and the warm air supplied to the blower chamber 72u is injected onto the back surface M2 of the printing medium M from each nozzle 76u.

The lower blower unit 71l has a blower chamber 72l extending in the horizontal direction X below the printing medium M. Both end surfaces of the blower chamber 72l in the horizontal direction X are planes perpendicular to the horizontal direction X and perpendicular to the vertical direction Z. To the blower chamber 72l, supplied is the warm air described above. The upper surface of the blower chamber 72l is a nozzle arrangement plane 731 facing, from below, the front surface M1 (lower surface) of the printing medium M facing downward. This nozzle arrangement plane 731 is a plane in parallel with the horizontal direction X and perpendicular to the vertical direction Z. Further, the blower unit 71l has a plurality of nozzles 76l aligned at a predetermined pitch in the horizontal direction X in this nozzle arrangement plane 731. Thus, the plurality of nozzles 76l are aligned between the nozzle arrangement plane 731 and the front surface M1 of the printing medium M to face the front surface M1 of the printing medium M. Each of the nozzles 76l communicates with the blower chamber 72l and the warm air supplied to the blower chamber 72l is injected onto the front surface M1 of the printing medium M from each nozzle 76l.

Thus, the blower unit 71u and the blower unit 71l sandwich the printing medium M. In other words, the printing medium M transported by the middle-stage transport part 51m passes between the blower unit 71u and the blower unit 71l. Thus, the blower dryer 7c injects the warm air onto the printing medium M transported by the middle-stage transport part 51m from the blower units 71u and 71l on both upper and lower sides, to thereby dry the printing medium M.

The upper nozzles 76u face a range between two lower nozzles 76l adjacent to each other in the horizontal direction X from above, and the lower nozzles 76l face a range between two upper nozzles 76u adjacent to each other in the horizontal direction X from below. Specifically, in the horizontal direction X, the upper nozzles 76u and the lower nozzles 76l are arranged alternately at a pitch which is half of a predetermined pitch and arranged alternately one by one in the horizontal direction X in a plan view from the vertical direction Z. In other words, the nozzles 76u and 76l are arranged in a staggered manner. Such a staggered arrangement of the nozzles 76u and 76l is achieved by shifting respective positions of the blower chambers 72u and 72l relative to each other in the horizontal direction X.

In such a configuration, as shown in FIG. 4, in a portion where the printing medium M faces the upper nozzle 76u, the printing medium M is pushed downward by the warm air from this nozzle 76u, to lean downward relative to a transport center line L, and in a portion where the printing medium M faces the lower nozzle 76l, the printing medium M is pushed upward by the warm air from this nozzle 76l, to lean upward relative to the transport center line L, Herein, the transport center line L is a horizontal virtual straight line whose respective distances from the nozzles 76u and 76l in the vertical direction Z are equal to each other. Therefore, the printing medium M is transported from the one side X1 toward the other side X2 in the horizontal direction X while waving between above and below the transport center line L.

The blower dryer 7d is disposed on the downstream side of the blower dryer 7c in the traveling direction of the printing medium M transported from the roller 522 toward the air turn bar 541. Like the blower dryer 7c, this blower dryer 7d has the blower units 71u and 71l which sandwich the printing medium M from the vertical direction Z. In this blower dryer 7d, the blower unit 71u injects the warm air onto the back surface M2 of the printing medium M from above and the blower unit 71l injects the warm air onto the front surface M1 of the printing medium M from below, to thereby dry the printing medium M.

Like the blower dryer 7a, the blower dryer 7e has the blower unit 71u arranged above the printing medium M and the plurality of rollers 74 coming into contact with the printing medium M from below. The blower dryer 7e, however, is disposed for the printing medium M transported from the air turn bar 542 to the roller 561. For this reason, the plurality of nozzles 76u provided in the blower unit 71u of the blower dryer 7e face the printing medium M transported from the air turn bar 542 toward the roller 561 from above. Further, the plurality of rollers 74 of the blower dryer 7e come into contact with the printing medium M transported from the air turn bar 542 toward the roller 561 from below. Thus, the blower dryer 7e has the plurality of nozzles 76u aligned at regular pitches in the horizontal direction X above the printing medium M and the plurality of rollers 74 (the same number as that of the nozzles 76u) aligned at regular pitches in the horizontal direction X below the printing medium M. The nozzles 76u and the rollers 74 are arranged in a staggered manner in the horizontal direction X as shown in FIGS. 2 and 3. Thus, in the blower dryer 7e, while the plurality of rollers 74 support the back surface M2 of printing medium M from below, the plurality of nozzles 76u inject warm air onto the front surface M1 of the printing medium M from above, to thereby dry the printing medium M.

The blower dryer 7f is disposed on the downstream side of the blower dryer 7e in the traveling direction of the printing medium M transported from the air turn bar 542 toward the roller 561. Like the blower dryer 7e, this blower dryer 7f has the plurality of nozzles 76u facing the printing medium M from above and the plurality of rollers 74 coming into contact with the printing medium M from below, and the nozzles 76u and the rollers 74 are arranged in a staggered manner in the horizontal direction X. Thus, in the blower dryer 7f, while the plurality of rollers 74 support the back surface M2 of printing medium M from below, the plurality of nozzles 76u inject warm air onto the front surface M1 of the printing medium M from above, to thereby dry the printing medium M.

The above-described nozzles 76u and 76l are extended in parallel with the horizontal direction Y. In the horizontal direction Y, the width of each of the nozzles 76u and 76l is larger than that of the printing medium M, and the printing medium M is transported so that both ends of the printing medium M can be positioned between both ends of the nozzles 76u and 76l. Similarly, each roller 74 is extended in parallel with the horizontal direction Y. In the horizontal direction Y, the width of each roller 74 is larger than that of the printing medium M, and the printing medium M is transported so that both ends of the printing medium M can be positioned between both ends of the rollers 74.

Further, the drying apparatus 5 includes exhaust parts 8a and 8b disposed inside the drying furnace 6 and the exhaust parts 8a and 8b each discharge the air from the inside of the drying furnace 6 to the outside of the drying furnace 6. The exhaust part 8a is disposed at an end portion of the other side X2 inside the drying furnace 6 and positioned between the blower dryers 7a, 7d, and 7e and the sidewall 6a. The exhaust part 8b is disposed at an end portion of one side X1 inside the drying furnace 6 and positioned between the blower dryers 7b, 7c, and 7f and the sidewall 6b. These exhaust parts 8a and 8b include a common constitution. The exhaust parts 8a and 8b each have four exhaust chambers 81 to 84 arranged in the vertical direction Z. The exhaust chamber 81 is disposed above the printing medium M transported by the upper-stage transport part 51u, the exhaust chamber 82 is disposed between the printing medium M transported by the upper-stage transport part 51u and the printing medium M transported by the middle-stage transport part 51m, the exhaust chamber 83 is disposed between the printing medium M transported by the middle-stage transport part 51m and the printing medium M transported by the lower-stage transport part 51l, and the exhaust chamber 84 is disposed below the printing medium M transported by the lower-stage transport part 51l. Each of the exhaust chambers 81 to 84 discharges the air sucked from the inside of the drying furnace 6 to the outside thereof.

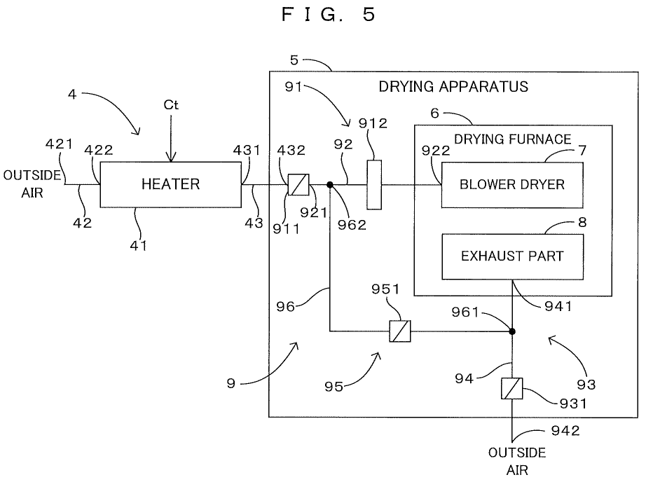

FIG. 5 is a block diagram showing a warm air supply unit for supplying warm air into the drying furnace. In this figure, the blower dryers 7a to 7f are each referred to as a blower dryer 7, not being distinguished from one another, and the exhaust parts 8a and 8b are each referred to as an exhaust part 8, not being distinguished from each other. The drying apparatus 5 has a warm air supply unit 9 shown in FIG. 5, and the warm air supply unit 9 supplies the warm air, which is generated by a warm air generation apparatus 4 provided separately from the drying apparatus 5, to each blower dryer 7 inside the drying furnace 6. Then, each blower dryer 7 injects the warm air supplied from the warm air supply unit 9 onto the printing medium M as described above.

The warm air generation apparatus 4 has a heater 41, an outside air introduction pipe 42 for introducing outside air into the heater 41, and a warm air output pipe 43 for outputting the warm air, which is generated by heating the outside air by the heater 41, into the warm air supply unit 9. One end of the outside air introduction pipe 42 is an inflow end 421 opened to the outside air having a room temperature and the other end of the outside air introduction pipe 42 is an outflow end 422 connected to the heater 41. One end of the warm air output pipe 43 is an inflow end 431 connected to the heater 41 and the other end of the warm air output pipe 43 is an outflow end 432 for outputting the warm air.

The outside air having flowed into the outside air introduction pipe 42 from the inflow end 421 flows out from the outflow end 422 to the heater 41. The heater 41 heats the outside air, that has flowed in from the outside air introduction pipe 42, using gas or electricity, to thereby generate warm air. This heater 41 heats the outside air so that the temperature detected by a temperature sensor (thermocouple), which detects the temperature of the warm air, becomes the temperature indicated by a warm air temperature command Ct. This temperature sensor is disposed outside the drying furnace 6 and, for example, detects the temperature of the warm air before flowing into the drying furnace 6 between a blower 912 described later and the drying furnace 6. Thus, the warm air generated by the heater 41 flows out into the warm air output pipe 43 from the heater 41 through the inflow end 431. The warm air, which has flowed into the warm air output pipe 43, flows out into the warm air supply unit 9 from the outflow end 432.

The warm air supply unit 9 includes a warm air supply part 91 supplying the warm air, which has flowed in from the warm air generation apparatus 4, to the blower dryer 7 inside the drying furnace 6, a warm air exhaust part 93 discharging the warm air, which is exhausted from the exhaust part 8, to the outside of the drying furnace 6, and a warm air collecting part 95 collecting a portion of the warm air, which is exhausted from the drying furnace 6 to the warm air exhaust part 93, into the warm air supply part 91.

The warm air supply part 91 has a motor damper 911 attached to the outflow end 432 of the warm air output pipe 43 and a warm air supply pipe 92 connecting the motor damper 911 and the blower dryer 7. One end of the warm air supply pipe 92 is an inflow end 921 connected to the motor damper 911. In other words, between the outflow end 432 of the warm air output pipe 43 and the inflow end 921 of the warm air supply pipe 92, provided is the motor damper 911. Therefore, the warm air, which has flowed out from the outflow end 432 of the warm air output pipe 43, passes through the motor damper 911 and then flows into the inflow end 921 of the warm air supply pipe 92. Further, the other end of the warm air supply pipe 92 is an outflow end 922 connected to the blower dryer 7.

Furthermore, the warm air supply part 91 has a blower 912 attached to the warm air supply pipe 92 between the inflow end 921 and the outflow end 922. The blower 912 drives the warm air inside the warm air supply pipe 92, to thereby generate an airflow going from the inflow end 921 toward the outflow end 922 along the warm air supply pipe 92. As a result, the warm air, which has flowed into the warm air supply pipe 92 from the heater 41 through the motor damper 911, is supplied into the blower dryer 7 by the airflow generated by the blower 912. As a result, the warm air supplied into the blower dryers 7a, 7b, 7e, and 7f is injected from the nozzles 76u of the blower chamber 72u, and the warm air supplied into the blower dryers 7c and 7d is injected from the nozzles 76u and 76l of the blower chambers 72u and 72l, respectively.

The warm air exhaust part 93 includes a warm air exhaust pipe 94 connected to the exhaust part 8. One end of the warm air exhaust pipe 94 is an inflow end 941 connected to the exhaust part 8, and the other end of the warm air exhaust pipe 94 is an outflow end 942 opened to the outside air. Further, the warm air exhaust part 93 includes a motor damper 931 attached to the warm air exhaust pipe 94 between the inflow end 941 and the outflow end 942. Therefore, the warm air, which has flowed into the warm air exhaust pipe 94 form the exhaust chambers 81, 82, 83, and 84 of the exhaust part 8 through the inflow end 941, passes through the motor damper 931 and then is discharged to outside air from the outflow end 942 of the warm air exhaust pipe 94.

The warm air collecting part 95 includes a warm air collecting pipe 96 connecting the warm air exhaust pipe 94 and the warm air supply pipe 92. One end of the warm air collecting pipe 96 is an inflow end 961 connected to the warm air exhaust pipe 94, and the other end of the warm air collecting pipe 96 is an outflow end 962 connected to the warm air supply pipe 92. The inflow end 961 is connected to the warm air exhaust pipe 94 between the inflow end 941 and the motor damper 931. The outflow end 962 is connected to the warm air supply pipe 92 between the inflow end 921 and the blower 912. Further, the warm air collecting part 95 includes a motor damper 951 attached to the warm air collecting pipe 96 between the inflow end 961 and the outflow end 962. Therefore, the warm air, which has flowed into the warm air collecting pipe 96 form the warm air exhaust pipe 94 through the inflow end 961, passes through the motor damper 951 and then is collected into the warm air supply pipe 92 from the outflow end 962 of the warm air collecting pipe 96. Thus, the warm air collected into the warm air supply pipe 92 is supplied into the blower dryer 7 by the blower 912.

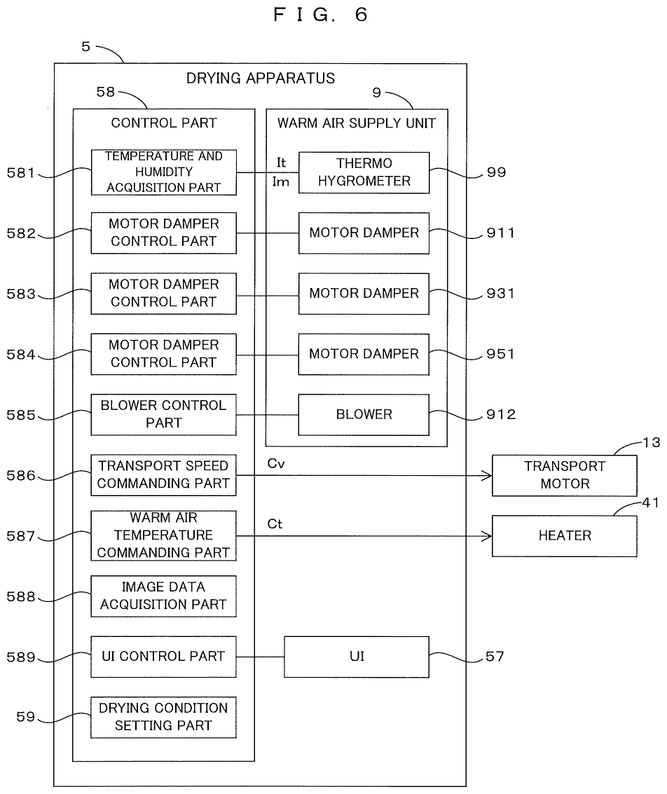

FIG. 6 is a block diagram showing an electrical configuration included in the drying apparatus. As shown in FIG. 6, the warm air supply unit 9 of the drying apparatus 5 includes a thermohygrometer 99. The thermohygrometer 99 is disposed outside the drying furnace 6 and detects a temperature It and a humidity Im (relative humidity) of the outside air. Further, no hygrometer is disposed inside the drying furnace 6. Furthermore, the drying apparatus 5 includes a UI 57 (User Interface). The UI 57 has an input device such as a mouse, a keyboard, and/or the like and an output device such as a display or the like, and receives an operation of a user inputted to the input device and outputs information to the user by using the output device. Further, it is not indispensable to form the input device and the output device separately, and these devices may be integrally formed as a touch panel display or the like.

Furthermore, the drying apparatus 5 includes a control part 58. The control part 58 is a processor and performs an arithmetic operation necessary to control the drying apparatus 5. This control part 58 includes a temperature and humidity acquisition part 581, motor damper control parts 582, 583, and 584, a blower control part 585, a transport speed commanding part 586, a warm air temperature commanding part 587, an image data acquisition part 588, a UI control part 589, and a drying condition setting part 59.

The temperature and humidity acquisition part 581 acquires a temperature It and a humidity Im of the outside air detected by the thermohygrometer 99. The temperature It and the humidity Im acquired by the thermohygrometer 99 are sent to the drying condition setting part 59.

The motor damper control part 582 controls the degree of opening of the motor damper 911, to thereby adjust the flow rate of the warm air flowing into the warm air supply pipe 92 from the warm air generation apparatus 4. The motor damper control part 583 controls the degree of opening of the motor damper 931, to thereby adjust the flow rate of the warm air discharged into the outside air from the exhaust part 8 through the warm air exhaust pipe 94. The motor damper control part 584 controls the degree of opening of the motor damper 951, to thereby adjust the flow rate of the warm air collected into the warm air supply pipe 92 from the warm air exhaust pipe 94 through the warm air collecting pipe 96. The blower control part 585 controls the number of rotation of the blower 912, to thereby adjust the flow rate of the warm air to be supplied into the blower dryer 7 through the warm air supply pipe 92.

The transport speed commanding part 586 determines the transport speed of the printing medium M inside the drying furnace 6 and sends a transport speed command Cv indicating the transport of the printing medium M at this transport speed to the transport motor 13. The transport motor 13 is a motor which transports the printing medium M, for example, a wind-up motor which rotates the wind-up roll 12. When the transport motor 13 receives the transport speed command Cv, the transport motor 13 transports the printing medium M at the transport speed indicated by the transport speed command Cv.

The warm air temperature commanding part 587 determines the temperature of the warm air to be supplied into the blower dryer 7 and sends the warm air temperature command Ct indicating generation of the warm air at this temperature to the heater 41. When the heater 41 receives the warm air temperature command Ct, the heater 41 generates the warm air having the temperature indicated by the warm air temperature command Ct.

The image data acquisition part 588 acquires submission data representing an image to be printed on the printing medium M by the printer 3. The submission data are data having, for example, a PDF (Portable Document Format format) format. The format of the submission data, however, is not limited to the PDF. Specifically, the image data acquisition part 588 can acquire the submission data having any one of various formats used in general. The image data acquisition part 588 receives, for example, from the printer 3, the submission data inputted to the printer 3, to thereby acquire the submission data. Alternatively, the image data acquisition part 588 acquires the submission data that the user inputs by using the UI 57. The submission data acquired by the image data acquisition part 588 is sent to the drying condition setting part 59.

The UI control part 589 acquires data that the user inputs by using the UI 57. Further, the UI control part 589 outputs various kinds of information to the user by performing a display on the display, or the like.

The drying condition setting part 59 sets a drying condition used for drying the printing medium M inside the drying furnace 6. This drying condition setting part 59 sets the drying condition on the basis of the humidity Im of the outside air detected by the thermohygrometer 99 and the submission data. Subsequently, the setting of drying condition will be described.

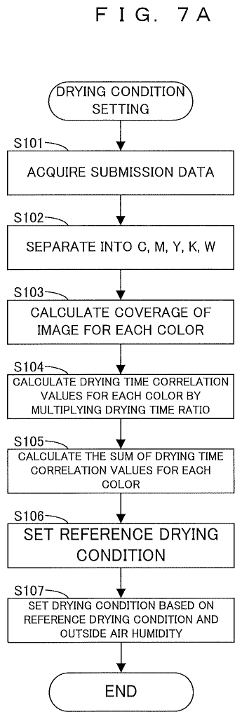

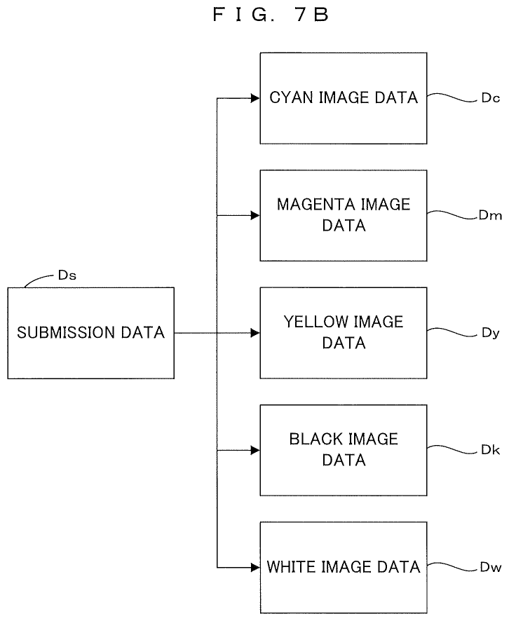

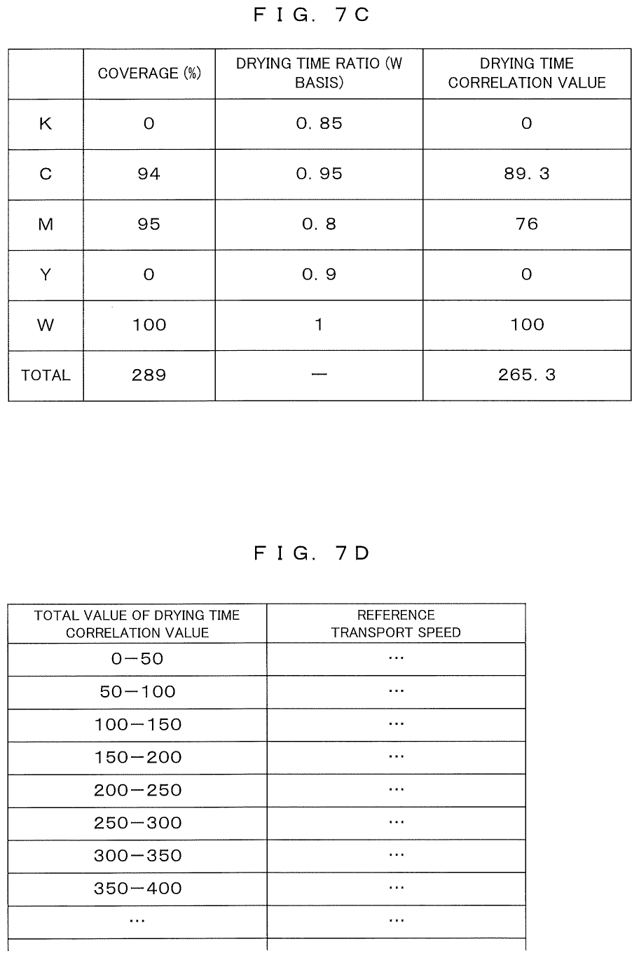

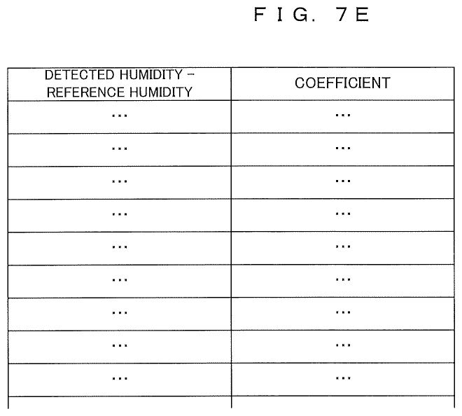

FIG. 7A is a flowchart showing a first example of drying condition determination performed by the control part of the drying apparatus, FIGS. 7B and 7C are views each schematically showing an exemplary arithmetic operation performed in the flowchart of FIG. 7A, and FIGS. 7D and 7E are views each schematically showing an exemplary table used for setting a drying condition in the flowchart of FIG. 7A.

In Step S101, the image data acquisition part 588 acquires the submission data Ds (FIG. 7B). In Step S102, the submission data Ds acquired by the image data acquisition part 588 are separated by the drying condition setting part 59 into image data Dc, Dm, Dy, Dk, and Dw of C (Cyan), M (Magenta), Y (Yellow), K (Black), and W (White), respectively (FIG. 7B).

In Step S103, the drying condition setting part 59 calculates a coverage (%) indicating a ratio of an area on which ink is deposited in the image represented by each of the image data Dc, Dm, Dy, Dk, and Dw. Thus, as shown in the column of “coverage (%)” in FIG. 7C, the respective coverages (0%, 94%, 95%, 0%, and 100%) of the images of K, C, M, Y, and W are calculated.

In Step S104, the drying condition setting part 59 calculates respective drying time correlation values (0, 89.3, 76, 0, and 100) obtained by multiplying the coverage by the drying time ratio for the colors K, C, M, Y, and W, respectively. Herein, the drying time ratio can be obtained as a ratio (0.85, 0.95, 0.8, 0.9, and 1) of the time required to dry the unit quantity of the ink of each of K, C, M, Y, and W to the time required to dry the unit quantity of the ink of, for example, W. The drying time ratio for each color is inputted to the UI control part 589 by, for example, the user operating the UI 57 and is stored in advance in the drying condition setting part 59. The drying time correlation value is a value having a correlation with the time (ink drying time) required to dry the ink, which is deposited onto the printing medium M to form an image, and the drying time correlation value becomes larger as the ink drying time becomes longer. In Step S105, the drying condition setting part 59 calculates the sum (265.3), i.e., a total value of the drying time correlation values for all the colors.

In Step S106, the drying condition setting part 59 sets a reference drying condition on the basis of the total value of the drying time correlation values. In this exemplary case, the drying condition setting part 59 sets a reference transport speed (reference drying condition) of the printing medium M on the basis of the table shown in FIG. 7D. Herein, the table of FIG. 7D indicates the correspondence relation between the total value of the drying time correlation values and the reference transport speed of the printing medium M. This table indicates, particularly, the correspondence relation between the total value of the drying time correlation values and the transport speed (reference transport speed) of the printing medium M in a case where the humidity detected by the thermohygrometer 99 is a reference humidity (e.g., 50%). The drying condition setting part 59 sets the reference transport speed of the printing medium M to be lower as the total value of the drying time correlation values becomes larger, in other words, the ink drying time becomes longer, on the basis of this table.

In Step S107, the drying condition setting part 59 sets the drying condition (transport speed) on the basis of the reference drying condition (reference transport speed) and the humidity Im detected by the thermohygrometer 99. Specifically, the drying condition setting part 59 adjusts the reference transport speed according to a difference between the reference humidity and the humidity Im, to thereby set the transport speed of the printing medium M. Specifically, the drying condition setting part 59 sets the transport speed of the printing medium M to be lower as the humidity Im detected by the thermohygrometer 99 becomes higher. Such setting of the transport speed can be performed, for example, as follows. Specifically, the drying condition setting part 59 stores the table of FIG. 7E, which provides a coefficient having a smaller value as a subtraction value obtained by subtracting the reference humidity from an actual humidity is larger. Then, the drying condition setting part 59 sets the transport speed obtained by multiplying the reference transport speed by the coefficient indicated by this table for the humidity Im detected by the thermohygrometer 99, as the transport speed of the printing medium M. When the drying condition setting part 59 sets the transport speed of the printing medium M thus, the transport speed commanding part 586 sends the transport speed command Cv indicating this transport speed to the transport motor 13. The printing medium M is thereby transported at this transport speed.

In the above-described embodiment, the warm air generated by heating the outside air is supplied into the drying furnace 6 by the warm air supply part 91. The temperature of the warm air is adjusted by the warm air temperature commanding part 587 (warm air temperature adjustment part). Further, the warm air, which is collected from the drying furnace 6 to the warm air supply part 91 by the warm air collecting part 95, is also supplied into the drying furnace 6. Inside this drying furnace 6, the printing medium M, on which an image formed of inks is printed, is transported by the transport part 51. The printing medium M is, particularly, transported at the transport speed indicated by the transport speed command Cv outputted from the transport speed commanding part 586. Then, the warm air supplied into the drying furnace 6 is guided to the printing medium M by the blower dryer 7 (warm air guide part), to thereby dry the printing medium M. In such a configuration, the ink deposited on the printing medium M to form the image and the humidity of the outside air significantly affect the humidity inside the drying furnace 6. Then, in this embodiment, the humidity Im (outside air data) of the outside air and the submission data Ds (print image information) are acquired. Then, the transport speed command Cv outputted from the transport speed commanding part 586 (transport part) is controlled on the basis of the humidity Im and submission data Ds. As a result, without providing any humidity sensor inside the drying furnace 6, it becomes possible to dry the printing medium M on the condition according to the humidity inside the drying furnace 6.

Furthermore, the control part 58 acquires the coverage (ink amount reflected value) reflecting the amount of ink deposited on the printing medium M on the basis of the submission data Ds, to thereby control the transport speed of the printing medium M on the basis of the humidity Im and the coverage. By performing control on the basis of the coverage thus, it becomes possible to dry the printing medium M on the condition (the transport speed of the printing medium M) according to the humidity inside the drying furnace 6.

Further, the control part 58 controls the transport speed of the printing medium M on the basis of the humidity Im and the drying time correlation value (combined value) which is obtained by combining the drying time ratio (drying time index value), according to the time for drying the ink deposited on the printing medium M, and the coverage. By performing control on the basis of the drying time correlation value obtained by combining the drying time ratio and the coverage thus, it becomes possible to dry the printing medium M on the condition according to the humidity inside the drying furnace 6.

Furthermore, the control part 58 decreases the transport speed of the printing medium M as the amount of ink reflected by the coverage becomes larger (in other words, as the coverage becomes higher). In such a configuration, it becomes possible to dry the printing medium M while transporting the printing medium M at the transport speed according to the humidity inside the drying furnace 6.

Further, the control part 58 decreases the transport speed of the printing medium M as the drying time indicated by the drying time ratio becomes longer. In such a configuration, it becomes possible to dry the printing medium M while transporting the printing medium M at the transport speed according to the humidity inside the drying furnace 6.

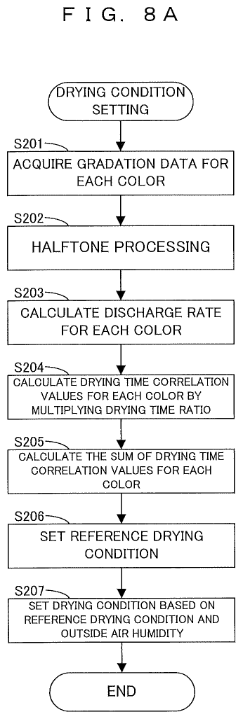

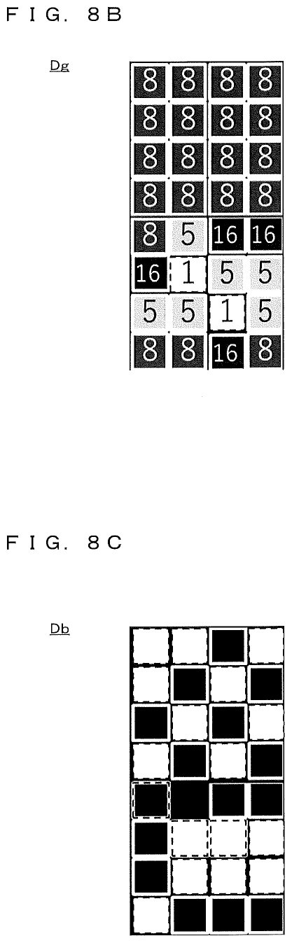

FIG. 8A is a flowchart showing a second example of drying condition determination performed by the control part of the drying apparatus, and FIGS. 8B and 8C are views each schematically showing an exemplary arithmetic operation performed in the flowchart of FIG. 8A.

In Step S201, the image data acquisition part 588 acquires gradation data Dg. As shown in FIG. 8B, the gradation data Dg represents a tone value of the image printed on the printing medium M in a plurality of levels (e.g., sixteen levels) for each pixel. The gradation data Dg are acquired for each of the colors, C (Cyan), M (Magenta), Y (Yellow), K (Black), and W (White). The image data acquisition part 588 acquires the gradation data Dg, for example, by receiving the gradation data Dg from the printer 3. Alternatively, the image data acquisition part 588 acquires the gradation data Dg inputted by the user using the UI 57.

In Step S202, halftone processing is performed by the drying condition setting part 59 on the gradation data Dg acquired by the image data acquisition part 588. This halftone processing is performed, for example, by using a threshold matrix. The threshold matrix represents a threshold value used for binarizing the tone value, for each pixel. The drying condition setting part 59 acquires binary data Db by performing an arithmetic operation to binarize the tone value by performing a comparison between the tone value of the gradation data Dg and the threshold value of the threshold matrix, for each pixel. As shown in FIG. 8C, the binary data Db represents whether or not there is a discharge of ink, for each pixel. The binary data Db are obtained for each of the colors, K, C, M, Y, and W.

In Step S203, the drying condition setting part 59 calculates a discharge rate of ink on the basis of the binary data Db. Specifically, among the number of all the pixels constituting the image, a ratio of the number of pixels in which there is a discharge of ink is calculated as the discharge rate. This discharge rate is obtained for each of the colors, K, C, M, Y, and W.

In Step S204, the drying condition setting part 59 calculates the drying time correlation value obtained by multiplying the discharge rate by the drying time ratio, for each of the colors, K, C, M, Y, and W. Further, in Step S205, the drying condition setting part 59 calculates a total value of the respective drying time correlation values of the colors, K, C, M, Y, and W. The arithmetic operations in Steps S204 and S205 correspond to the arithmetic operation shown in FIG. 7C with the discharge rate used instead of the coverage.

In Step S206, the drying condition setting part 59 sets the reference drying condition on the basis of the total value of the drying time correlation values. In Step S207, the drying condition setting part 59 sets the drying condition (transport speed) on the basis of the reference drying condition (reference transport speed) and the humidity Im detected by the thermohygrometer 99. Steps S206 and S207 can be executed, for example, by using the table, like in Steps S106 and S107. Then, the transport speed commanding part 586 sends the transport speed command Cv indicating this transport speed to the transport motor 13. The printing medium M is thereby transported by this transport speed.

In the above-described embodiment, the warm air generated by heating the outside air is supplied into the drying furnace 6 by the warm air supply part 91. The temperature of the warm air is adjusted by the warm air temperature commanding part 587 (warm air temperature adjustment part). Further, the warm air collected from the drying furnace 6 to the warm air supply part 91 by the warm air collecting part 95 is also supplied into the drying furnace 6. Inside this drying furnace 6, the printing medium M, on which an image formed of inks is printed, is transported by the transport part 51. The printing medium M is, particularly, transported at the transport speed indicated by the transport speed command Cv outputted from the transport speed commanding part 586. Then, the warm air supplied into the drying furnace 6 is guided to the printing medium M by the blower dryer 7 (warm air guide part) x, to thereby dry the printing medium M. In such a configuration, the ink deposited on the printing medium M to form the image and the humidity of the outside air significantly affect the humidity inside the drying furnace 6. Then, in this embodiment, the humidity Im (outside air data) of the outside air and the gradation data Dg (print image information) are acquired. Then, the transport speed command Cv outputted from the transport speed commanding part 586 (transport part) is controlled on the basis of the humidity Im and gradation data Dg. As a result, without providing any humidity sensor inside the drying furnace 6, it becomes possible to dry the printing medium M on the condition according to the humidity inside the drying furnace 6.

Furthermore, the control part 58 acquires the discharge rate (ink amount reflected value) reflecting the amount of ink deposited on the printing medium M on the basis of the gradation data Dg, to thereby control the transport speed of the printing medium M on the basis of the humidity Im and the discharge rate. By performing control on the basis of the discharge rate thus, it becomes possible to dry the printing medium M on the condition (the transport speed of the printing medium M) according to the humidity inside the drying furnace 6.

Further, the control part 58 controls the transport speed of the printing medium M on the basis of the humidity Im and the drying time correlation value (combined value) which is obtained by combining the drying time ratio (drying time index value), according to the drying time of the ink deposited on the printing medium M, and the discharge rate (ink amount reflected value). By performing control on the basis of the combined value of the drying time ratio and the discharge rate thus, it becomes possible to dry the printing medium M on the condition (the transport speed of the printing medium M) according to the humidity inside the drying furnace 6.

Furthermore, the control part 58 decreases the transport speed of the printing medium M as the amount of ink reflected by the discharge rate becomes larger (in other words, as the discharge rate becomes higher). In such a configuration, it becomes possible to dry the printing medium M while transporting the printing medium M at the transport speed according to the humidity inside the drying furnace 6.

Further, the control part 58 decreases the transport speed of the printing medium M as the drying time indicated by the drying time ratio becomes longer. In such a configuration, it becomes possible to dry the printing medium M while transporting the printing medium M at the transport speed according to the humidity inside the drying furnace 6.

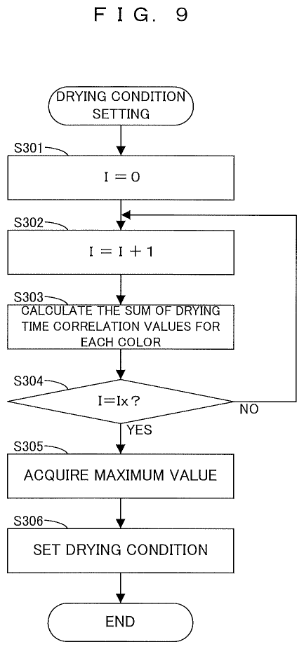

FIG. 9 is a flowchart showing a third example of drying condition determination performed by the control part of the drying apparatus. In the exemplary case shown in FIG. 9, the image printed on the printing medium M is divided into a plurality of (Ix) target areas, and the drying time correlation values are calculated for each of the target areas.

The drying condition setting part 59 resets a count value I for identifying the target area to zero (Step S301), and increments the count value I by 1 (Step S302). Then, the drying condition setting part 59 calculates a total value of the drying time correlation values of the colors, K, C, M, Y, and W in the target area indicated by the count value I (Step S303). Further, the method of calculating the total value of the drying time correlation values is the same as that of the first example or the second example. Then, Step S303 is repeatedly executed until the count value I coincides with the value Ix.

When the total value of the drying time correlation values is calculated for each of the Ix target areas and Ix total values are acquired (“YES” in Step S304), the drying condition setting part 59 acquires the maximum value of the Ix total values (Step S305). In Step S306, the drying condition (the transport speed of the printing medium M) is set based on the maximum value of the total values. Specifically, the reference transport speed is calculated from the maximum value of the total values by using the table like that in FIG. 7D, and the transport speed is calculated from the reference transport speed by using the table like that in FIG. 7E.

Thus, the control part 58 calculates the drying time correlation values for each of the plurality of target areas included in the image printed on the printing medium M. Then, the control part 58 controls the transport speed of the printing medium M on the basis of (the total value of) the drying time correlation values in one target area which satisfies a condition (predetermined condition) that the total value of the drying time correlation values for all the colors is the maximum value among the plurality of target areas. In such a configuration, even in a case, for example, where there is locally a portion requiring time to dry, it becomes possible to dry the printing medium M on the condition (the transport speed of the printing medium M) according to the humidity inside the drying furnace 6.

As described above, in the present embodiment, the drying furnace 6 corresponds to one example of a “drying furnace” of the disclosure, the printing medium M corresponds to one example of a “printing medium” of the disclosure, the transport part 51 and the transport speed commanding part 586 correspond to one example of a “transport part” of the disclosure, the warm air supply part 91 corresponds to one example of a “warm air supply part” of the disclosure, the warm air temperature commanding part 587 corresponds to one example of a “warm air temperature adjustment part” of the disclosure, the blower dryer 7 corresponds to one example of a “warm air guide part” of the disclosure, the warm air collecting part 95 corresponds to one example of a “warm air collecting part” of the disclosure, the control part 58 corresponds to one example of a “control part” of the disclosure, the humidity Im corresponds to one example of “outside air data” of the disclosure, the thermohygrometer 99 corresponds to one example of an “outside air data acquisition part” of the disclosure, the submission data Ds or gradation data Dg correspond to one example of “print image information” of the disclosure, the image data acquisition part 588 corresponds to one example of a “print image information acquisition part” of the disclosure, and the drying apparatus 5 corresponds to one example of a “drying apparatus” of the disclosure.

Further, the disclosure is not limited to the above-described embodiment, but numerous modifications and variations other than those described above can be devised without departing from the scope of the disclosure. For example, the drying condition set in Step S107, S207, or S306 is not limited to the above-described transport speed of the printing medium M.

For example, the temperature of the warm air indicated by the warm air temperature command Ct outputted by the warm air temperature commanding part 587 may be set as the drying condition. In this exemplary case, the drying condition setting part 59 sets the temperature of the warm air indicated by the warm air temperature command Ct to be higher as the total value of the drying time correlation values becomes larger, in other words, the ink drying time becomes longer. Further, the drying condition setting part 59 sets the temperature of the warm air indicated by the warm air temperature command Ct to be higher as the humidity Im becomes higher.

Specifically the control part 58 sets the temperature of the warm air indicated by the warm air temperature command Ct to be higher as the amount of ink indicated by the coverage or the discharge rate becomes larger. It thereby becomes possible to dry the printing medium M with the warm air having a temperature according to the humidity inside the drying furnace 6.

Further, the control part 58 sets the temperature of the warm air indicated by the warm air temperature command Ct to be higher as the drying time indicated by the drying time ratio becomes longer. In such a configuration, it becomes possible to dry the printing medium M with the warm air having a temperature according to the humidity inside the drying furnace 6.

Alternatively, the number of rotation of the blower 912 controlled by the blower control part 585, in other words, the flow rate of the warm air supplied into the drying furnace 6 by the warm air supply part 91 may be set as the drying condition. In this exemplary case, the drying condition setting part 59 sets the flow rate of the warm air supplied into the drying furnace 6 by the warm air supply part 91 to be higher as a total value of the drying time correlation values becomes larger, in other words, the ink drying time becomes longer. Further, the drying condition setting part 59 sets the flow rate of the warm air supplied into the drying furnace 6 by the warm air supply part 91 to be higher as the humidity IM becomes higher.

Specifically, the control part 58 increases the flow rate of the warm air supplied into the drying furnace 6 by the warm air supply part 91 as the amount of ink indicated by the coverage or the discharge rate becomes larger. In such a configuration, it becomes possible to dry the printing medium M with the warm air having a flow rate according to the humidity inside the drying furnace 6.

Further, the control part 58 increases the flow rate of the warm air supplied into the drying furnace 6 by the warm air supply part 91 as the drying time indicated by the drying time ratio becomes longer. In such a configuration, it becomes possible to dry the printing medium M with the warm air having a flow rate according to the humidity inside the drying furnace 6.

Alternatively, the degree of opening of the motor damper 951 controlled by the motor damper control part 584, in other words, the flow rate of the warm air collected from the warm air exhaust pipe 94 through the warm air collecting pipe 96 into the warm air supply pipe 92 may be set as the drying condition. In this exemplary case, the drying condition setting part 59 sets the flow rate of the warm air collected from the warm air exhaust pipe 94 through the warm air collecting pipe 96 into the warm air supply pipe 92 to be lower as a total value of the drying time correlation values becomes larger. Further, the drying condition setting part 59 sets the flow rate of the warm air collected from the warm air exhaust pipe 94 through the warm air collecting pipe 96 into the warm air supply pipe 92 to be lower as the humidity IM becomes higher.

Specifically, the control part 58 reduces the flow rate of the warm air collected into the warm air supply pipe 92 through the warm air collecting pipe 96 as the amount of ink indicated by the coverage or the discharge rate becomes larger. In such a configuration, it becomes possible to dry the printing medium M while collecting the warm air having the amount according to the humidity inside the drying furnace 6 into the warm air supply part 91 from the drying furnace 6.

Further, the control part 58 reduces the flow rate of the warm air collected into the warm air supply pipe 92 through the warm air collecting pipe 96 as the drying time indicated by the drying time ratio becomes longer. In such a configuration, it becomes possible to dry the printing medium M while collecting the warm air having the amount according to the humidity inside the drying furnace 6 into the warm air supply part 91 from the drying furnace 6.

Furthermore, various changes can be made other than the control target of the control part 58. For example, the coverage or the discharge rate may be used itself as the drying time correlation value, not using the drying time ratio.

Further, as described above, inside the drying furnace 6 of the drying apparatus 5, provided are the plurality of (eight in total) blower chambers 72u and 72l. Then, there may be a configuration where the warm air supply pipe 92 has a manifold which branches out into a plurality of outflow ends 922 and the plurality of outflow ends 922 are connected to the plurality of blower chambers 72u and 72l, respectively.

Furthermore, the specific configuration for supplying the warm air to the blower dryers 7a to 7e is not limited to the exemplary configuration using the manifold. Specifically, the warm air generation apparatus 4 and the warm air supply part 91 may be provided in each of the plurality of blower dryers 7a to 7e.

Further, as described above, inside the drying furnace 6 of the drying apparatus 5, provided are the plurality of (eight in total) exhaust chambers 81, 82, 83, and 84. Then, there may be a configuration where the warm air exhaust pipe 94 has a manifold which branches out into a plurality of inflow ends 941 and the plurality of inflow ends 941 are connected to the plurality of exhaust chambers 81, 82, 83, and 84, respectively.

Furthermore, the specific configuration for discharging the warm air from the plurality of exhaust chambers 81, 82, 83, and 84 is not limited to the exemplary configuration using the manifold. Specifically, the warm air exhaust part 93 may be provided in each of the plurality of exhaust chambers 81, 82, 83, and 84.

Further, instead of the thermohygrometer 99, a hygrometer for acquiring only the humidity Im among the temperature It and the humidity Im may be provided.

Furthermore, the arrangement of the rollers 74 inside the drying furnace 6 can be changed as appropriate. In the lower-stage transport part 51l, for example, the blower unit 71l may be disposed, instead of the rollers 74.

Further, the number of colors of the inks forming the image printed on the printing medium M is not limited to the above-described exemplary number. Specifically, an image formed of ink of a single color or inks of a plurality of arbitrary colors can be printed on the printing medium M.

The disclosure is applicable to a technique in general for drying a printing medium on which an image formed of inks is printed.

The drying apparatus may be configured so that the control part acquires an ink amount reflected value reflecting the amount of ink deposited on the printing medium on the basis of the print image information, to thereby control the control target on the basis of the outside air data and the ink amount reflected value. Thus, by performing control on the basis of the ink amount reflected value, it becomes possible to dry the printing medium on the condition according to the humidity inside the drying furnace.

Further, various specific examples of the ink amount reflected value can be considered. For example, the drying apparatus may be configured so that the control part acquires a coverage indicating a ratio of an area on which ink is deposited in the image, as the ink amount reflected value. The drying apparatus may be configured so that the control part acquires respective tone values of a plurality of pixels constituting the image, from the print image information, and acquires the ink amount reflected value on the basis of a result of binarizing the tone values.

The drying apparatus may be configured so that the control part controls the control target on the basis of the outside air data and a combined value obtained by combining a drying time index value according to a drying time of ink deposited on the printing medium and the ink amount reflected value. Thus, by performing control on the basis of the combined value of the drying time index value and the ink amount reflected value, it becomes possible to dry the printing medium on the condition according to the humidity inside the drying furnace.

The drying apparatus may be configured so that the control part calculates the combined value for each of a plurality of target areas included in the image and controls the control target on the basis of a combined value of one target area satisfying a predetermined condition among the plurality of target areas. In such a configuration, even in a case, for example, where there is locally a portion requiring time to dry, it becomes possible to dry the printing medium on the condition according to the humidity inside the drying furnace.

The drying apparatus may be configured so that the control part decreases a speed at which the transport part transports the printing medium as the amount of ink reflected by the ink amount reflected value becomes larger. In such a configuration, it becomes possible to dry the printing medium while transporting the printing medium at a transport speed according to the humidity inside the drying furnace.

The drying apparatus may be configured so that the control part decreases a speed at which the transport part transports the printing medium as a drying time indicated by the drying time index value becomes longer. In such a configuration, it becomes possible to dry the printing medium while transporting the printing medium at a transport speed according to the humidity inside the drying furnace.

The drying apparatus may be configured so that the control part raises a temperature of warm air adjusted by the warm air temperature adjustment part as the amount of ink reflected by the ink amount reflected value becomes larger. In such a configuration, it becomes possible to dry the printing medium with the warm air having a temperature according to the humidity inside the drying furnace.

The drying apparatus may be configured so that the control part raises a temperature of warm air adjusted by the warm air temperature adjustment part as a drying time indicated by the drying time index value becomes longer. In such a configuration, it becomes possible to dry the printing medium with the warm air having a temperature according to the humidity inside the drying furnace.

The drying apparatus may be configured so that the control part controls the warm air supply part, and the control part increases a flow rate of warm air supplied into the drying furnace by the warm air supply part as the amount of ink reflected by the ink amount reflected value becomes larger. In such a configuration, it becomes possible to dry the printing medium with the warm air having a flow rate according to the humidity inside the drying furnace.

The drying apparatus may be configured so that the control part controls the warm air supply part, and the control part increases a flow rate of warm air supplied into the drying furnace by the warm air supply part as a drying time indicated by the drying time index value becomes longer. In such a configuration, it becomes possible to dry the printing medium with the warm air having a flow rate according to the humidity inside the drying furnace.

The drying apparatus may be configured so that the control part reduces a flow rate of warm air collected by the warm air collecting part into the warm air supply part as the amount of ink reflected by the ink amount reflected value becomes larger. In such a configuration, it becomes possible to dry the printing medium while collecting the warm air in the amount according to the humidity inside the drying furnace from the drying furnace into the warm air supply part.

The drying apparatus may be configured so that the control part reduces a flow rate of warm air collected by the warm air collecting part into the warm air supply part as a drying time indicated by the drying time index value becomes longer. In such a configuration, it becomes possible to dry the printing medium while collecting the warm air in the amount according to the humidity inside the drying furnace from the drying furnace into the warm air supply part.

Although the disclosure has been described with reference to specific embodiments, this description is not meant to be construed in a limiting sense. Various modifications of the disclosed embodiment, as well as other embodiments of the present disclosure, will become apparent to persons skilled in the art upon reference to the description of the disclosure. It is therefore contemplated that the appended claims will cover any such modifications or embodiments as fall within the true scope of the disclosure.

What is claimed is:

1. A drying apparatus, comprising:
a drying furnace;
a transport part which transports a printing medium, on which an image formed of inks is printed, inside the drying furnace;
a warm air supply part which takes in warm air generated by heating outside air, which is air outside the drying furnace, and supplies the warm air into the drying furnace;
a warm air temperature adjustment part which adjusts a temperature of warm air taken in by the warm air supply part;
a warm air guide part which guides warm air supplied into the drying furnace by the warm air supply part to the printing medium transported by the transport part;
a warm air collecting part which collects warm air discharged from the drying furnace into the warm air supply part; and
a control part which controls at least one control target among the transport part, the warm air temperature adjustment part, and the warm air collecting part,
wherein the warm air supply part supplies warm air collected by the warm air collecting part into the drying furnace, and
the control part has an outside air data acquisition part which acquires outside air data indicating at least the amount of water vapor contained in the outside air and a print image information acquisition part which acquires print image information of an image printed on the printing medium and controls the control target on the basis of the outside air data and the print image information.

2. The drying apparatus according to claim 1, wherein
the control part acquires an ink amount reflected value reflecting the amount of ink deposited on the printing medium on the basis of the print image information, to thereby control the control target on the basis of the outside air data and the ink amount reflected value.

3. The drying apparatus according to claim 2, wherein
the control part acquires a coverage indicating a ratio of an area on which ink is deposited in the image, as the ink amount reflected value.

4. The drying apparatus according to claim 2, wherein
the control part acquires respective tone values of a plurality of pixels constituting the image, from the print image information, and acquires the ink amount reflected value on the basis of a result of binarizing the tone values.

5. The drying apparatus according to claims 2, wherein
the control part controls the control target on the basis of the outside air data and a combined value obtained by combining a drying time index value according to a drying time of ink deposited on the printing medium and the ink amount reflected value.

6. The drying apparatus according to claim 5, wherein
the control part calculates the combined value for each of a plurality of target areas included in the image and controls the control target on the basis of a combined value of one target area satisfying a predetermined condition among the plurality of target areas.

7. The drying apparatus according to claim 2, wherein
the control part decreases a speed at which the transport part transports the printing medium as the amount of ink reflected by the ink amount reflected value becomes larger.

8. The drying apparatus according to claim 5, wherein
the control part decreases a speed at which the transport part transports the printing medium as a drying time indicated by the drying time index value becomes longer.

9. The drying apparatus according to claim 2, wherein
the control part raises a temperature of warm air adjusted by the warm air temperature adjustment part as the amount of ink reflected by the ink amount reflected value becomes larger.

10. The drying apparatus according to claim 5, wherein
the control part raises a temperature of warm air adjusted by the warm air temperature adjustment part as a drying time indicated by the drying time index value becomes longer.

11. The drying apparatus according to claim 2, wherein
the control part controls the warm air supply part, and
the control part increases a flow rate of warm air supplied into the drying furnace by the warm air supply part as the amount of ink reflected by the ink amount reflected value becomes larger.

12. The drying apparatus according to claim 5, wherein
the control part controls the warm air supply part, and
the control part increases a flow rate of warm air supplied into the drying furnace by the warm air supply part as a drying time indicated by the drying time index value becomes longer.

13. The drying apparatus according to claim 2, wherein
the control part reduces a flow rate of warm air collected by the warm air collecting part into the warm air supply part as the amount of ink reflected by the ink amount reflected value becomes larger.

14. The drying apparatus according to claim 5, wherein
the control part reduces a flow rate of warm air collected by the warm air collecting part into the warm air supply part as a drying time indicated by the drying time index value becomes longer.

15. A drying method, comprising:
transporting a printing medium, on which an image formed of inks is printed, by a transport part inside a drying furnace;
taking in warm air generated by heating outside air, which is air outside the drying furnace, and supplying the warm air into the drying furnace by a warm air supply part;
adjusting a temperature of warm air that the warm air supply part takes in by a warm air temperature adjustment part;
guiding warm air supplied into the drying furnace by the warm air supply part to the printing medium transported by the transport part, by a warm air guide part;
collecting warm air discharged from the drying furnace into the warm air supply part by a warm air collecting part; and
controlling at least one control target among the transport part, the warm air temperature adjustment part, and the warm air collecting part by a control part,
wherein the warm air supply part supplies warm air collected by the warm air collecting part into the drying furnace, and
the control part has an outside air data acquisition part, which acquires outside air data indicating at least the amount of water vapor contained in the outside air, and a print image information acquisition part, which acquires print image information of an image printed on the printing medium, and controls the control target on the basis of the outside air data and the print image information.
